(19) United States
(12) Patent Application Publication
(10) Pub. No.: US 2018/0090259 A1
(43) Pub. Date: Mar. 29, 2018

(54) COIL DEVICE

(71) Applicant: TDK CORPORATION, Tokyo (JP)

(72) Inventors: Yuji SEZAI, Tokyo (JP); Hironobu FURUKAWA, Tokyo (JP); Nobuo TAKAGI, Tokyo (JP)

(73) Assignee: TDK CORPORATION, Tokyo (JP)

(21) Appl. No.: 15/717,404

(22) Filed: Sep. 27, 2017

(30) Foreign Application Priority Data
Sep. 29, 2016 (JP) 2016-192160

(51) Int. Cl. H01F 27/255; H01F 27/28; H01F 27/29

(52) U.S. Cl. CPC H01F 27/255; H01F 27/29; H01F 27/28

(57) ABSTRACT

A coil device including: a core, including a magnetic powder and a resin; an air-core coil; a lead, led from the air-core coil; and a terminal, in which at least the entire air-core coil is buried inside the core, an outer shape of the core is a shape where at least one corner part is removed from an approximate rectangular parallelepiped shape, the removed corner includes an entire side of the approximate rectangular parallelepiped shape in the removed corner, approximately parallel to a direction of a winding axis of the air-coil, and a volume of the removed part is 2% or more of a volume of the approximate rectangular parallelepiped shape, is provided. The coil device can reduce a used amount of the magnetic body while maintaining the magnetic characteristic.

### BACKGROUND OF THE INVENTION

### 1. Field of the Invention

The present invention relates to a coil device having an air-core coil and a core in which the air-core coil is buried. In particular, the coil device is preferably mounted on a power supply circuit.

### 2. Description of the Related Art

Recently, due to a miniaturization and a high performance of the electronic devices, there is an increasing requirement for a miniaturized coil device showing high performances which can cope with a high frequency and a large current in a power circuit, such as a DC-DC converter driving the electronic devices.

Conventionally, a coil-sealed magnetic device is known as the coil device which can attain the above requirement. The coil-sealed magnetic device buries a wire wound around air-core coil in a dust core, obtained by mixing a magnetic powder and a resin and pressure molding thereof. See such as Patent Article 1.

In order to obtain the miniaturized coil device showing high performances, it is important to suppress a magnetic saturation during a power drive by obtaining a high inductance and holding said high inductance till a large current range. In order to realize miniaturization while suppressing the magnetic saturation, it is important to efficiently use the core in total, by making a distribution of the magnetic flux density, generated in the core composed of a magnetic body, closer to uniform. Note, such as DC superposition characteristic is exemplified as an index showing a magnetic saturation characteristic.

As is shown in Patent Article 1, a coil-sealed magnetic device generally has a configuration, in which the air-core coil of a cylindrical shape is buried inside the core having a rectangular parallelepiped shape. FIG. 8A shows said configuration. Further, FIG. 8B is a figure of coil-sealed magnetic device 100 in a view from the direction of the winding axis of air-core coil 40. An outer circumference shape of the magnetic body, intermediate leg 21 of core 20, disposed inside air-core coil 40 is a round shape. While the outer circumference shape of the magnetic body, external leg 22 of core 20, disposed outside the air-core coil is a quadrangle, or a square shape.

As shown in FIG. 8B, a magnetic flux, flowing from intermediate leg 21 of core 20 to external leg 22 of core 20, namely, from inside to outside of air-core coil 40, proceeds along the outer circumference shape of intermediate leg 21. Thus, the direction of said magnetic flux becomes radial. On the other hand, a magnetic flux densities generated at the areas nearby the corner parts (areas surrounded by dotted lines in FIG. 8B) of external leg 22, formed distant from the air-core coil, becomes extremely low. Thus, there is a problem that it is difficult to effectively use the entire core 20 made from the magnetic body.

### DISCLOSURE OF THE INVENTION

### Means for Solving the Problems

The present invention was devised considering the above problems. An object of the invention is to provide a coil device which can reduce a used amount of the magnetic body, while maintaining the magnetic characteristics.

[1] A coil device including:

a core, including a magnetic powder and a resin;

an air-core coil;

a lead, led from the air-core coil; and

a terminal, in which

at least the entire air-core coil is buried inside the core,

an outer shape of the core is a shape where at least one corner part is removed from an approximate rectangular parallelepiped shape,

the removed corner includes an entire side of the approximate rectangular parallelepiped shape in the removed corner, approximately parallel to a direction of a winding axis of the air-coil, and

a volume of the removed part is 2% or more of a volume of the approximate rectangular parallelepiped shape.

According to the coil device having the above described configuration, the used amount of the magnetic body can be reduced while the magnetic characteristics are similar, in relative to the coil device having the core of an approximate rectangular parallelepiped shape.

[2] The coil device according to [1], in which the corner part is removed by C chamfering.

The corner parts can be easily removed by C chamfering.

[3] The coil device according to [1] or [2], in which two or more of the corner parts are removed.
[4] The coil device according to [1] or [2], in which three or more of the corner parts are removed.
[5] The coil device according to [1] or [2], in which four of the corner parts are removed.

According to the coil device having the above configuration, the used amount of the magnetic body can be reduced, while maintaining the magnetic characteristics.

[5] The coil device according to [5], in which the outer shape of the core is an approximate regular octagonal pillar shape.

According to the coil device having the above described configuration, the used amount of the magnetic body can be reduced while maintaining the magnetic characteristics. In addition, manufacturing and mounting methods thereof become easy.

### BRIEF DESCRIPTION OF THE DRAWINGS

FIG. 1A is a perspective view of the coil device according to the first embodiment of the invention. FIG. 1B is a perspective plane view of the coil device according to the first embodiment of the invention.

FIG. 2 is a sectional view of the air-core coil part and the lead part.

FIG. 3A is a perspective view showing the removed corner parts of the coil device according to the first embodiment of the invention. FIG. 3B is a perspective plane view showing the removed corner parts of the coil device according to the first embodiment of the invention.

FIG. 4 is a view showing a removing range of the corner part.

FIG. 5A is a perspective view of the coil device according to the second embodiment of the invention. FIG. 5B is a perspective plane view of the coil device according to the second embodiment of the invention.

FIG. 6A is a perspective view of the coil device according to the third embodiment of the invention. FIG. 6B is a perspective plane view of the coil device according to the third embodiment of the invention.

FIG. 7A is a perspective view of the coil device according to the fourth embodiment of the invention. FIG. 7B is a perspective plane view of the coil device according to the fourth embodiment of the invention.

FIG. 8A is a perspective view of the coil device according to a conventional example. FIG. 8B is a perspective plane view of the coil device according to a conventional example.

Hereinafter, the present invention will be described in detail in the following order, referring to the embodiments shown in figures.

1. Coil device

1.1 The first embodiment

1.2 The second embodiment

1.3 The third embodiment

1.4 The fourth embodiment

2. Effects of the embodiments

### 3. Modified Examples 1. Coil Device

### 1.1 The First Embodiment

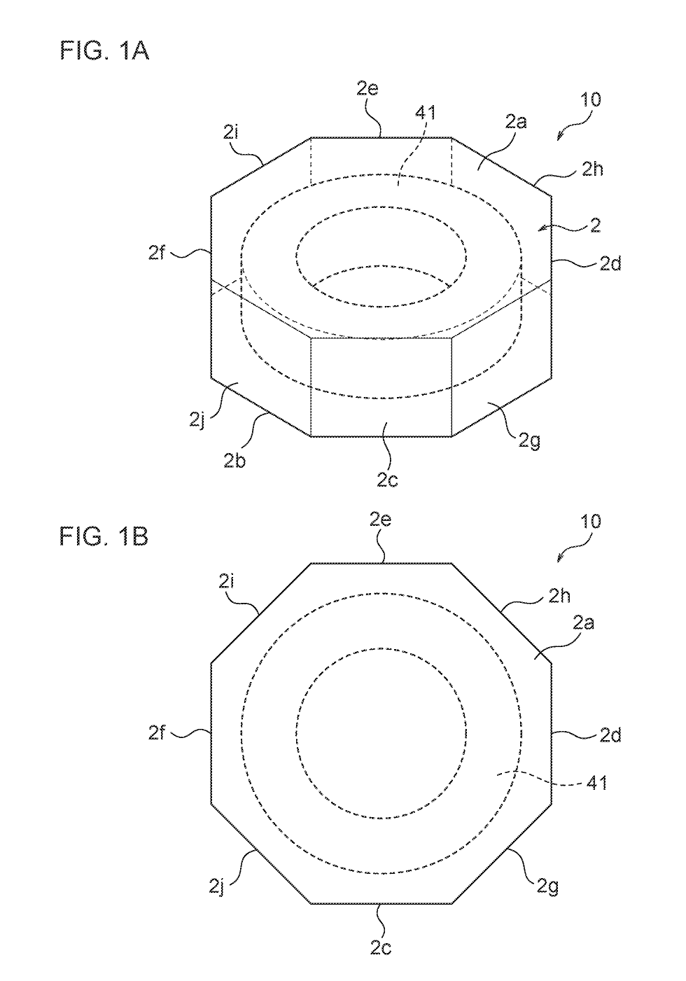

As shown in FIGS. 1A and 1B, coil device 10 according to the first embodiment includes core 2 of a compression molded body, air-core coil 41 formed by winding around a wire, a not shown lead part led from air-core coil 41, a not shown terminal part, electrically connected to the lead part and mounted on an outer circumference of core 2. The entire air-core coil 41 is buried inside core 2. Thus, air-core coil 41 cannot be observed from outside according to the actual coil device 10.

As shown in FIGS. 1A and 1B, outer shape of core 2 is a regular octagonal pillar shape, in which a first principal surface 2a and a second principal surface 2b of a regular octagonal shape are connected via eight outer circumferential surfaces (the first outer circumferential surface 2c, the second outer circumferential surface 2d, the third outer circumferential surface 2e, the fourth outer circumferential surface 2f, the fifth outer circumferential surface 2g, the sixth outer circumferential surface 2h, the seventh outer circumferential surface 2i and the eighth outer circumferential surface 2j) of a rectangular shape.

In the present embodiment, the fifth outer circumferential surface 2g, the sixth outer circumferential surface 2h, the seventh outer circumferential surface 2i and the eighth outer circumferential surface 2j are the surfaces, formed by removing the corner part of an equilateral quadrangular pillar, which will be described hereinafter.

Core 2 is formed by a compression molding or an injection molding a granule, including a magnetic powder and a resin of a binder binding magnetic particles included in the magnetic powder, and then heat treating thereof. Material of the magnetic powder is not limited, as long as it exhibits a predetermined magnetic characteristic. For instance, Fe—Si (iron-silicon), Sendust (Fe—Si—Al; iron-silicon-aluminium), Fe—Si—Cr (iron-silicon-chrome), Permalloy (Fe—Ni), an ironic based, such as a carbonyl iron based, metal magnetic body are exemplified. In addition, ferrites can be such as a Mn—Zn based ferrite, a Ni—Cu—Zn based ferrite, etc.

The resin as the binder is not particularly limited, however, an epoxy resin, a phenol resin, an acryl resin, a polyester resin, a polyimide, a polyamide imide, a silicon resin, a combination thereof, etc, are exemplified.

A wire, constituting the air-core coil part and the lead part is for instance, composed of a lead wire and an insulating coating layer coating the outer circumference of the lead wire, when necessary. The lead wire is composed of, for instance, Cu, Al, Fe, Ag, Au, phosphor bronze, etc. The insulating coating layer is composed of, for instance, polyurethane, polyamide imide, polyimide, polyester, polyester-imide, polyester-nylon, etc. A cross-sectional shape of the wire is not particularly limited, and may be a round shape, a straight angle shape, etc.

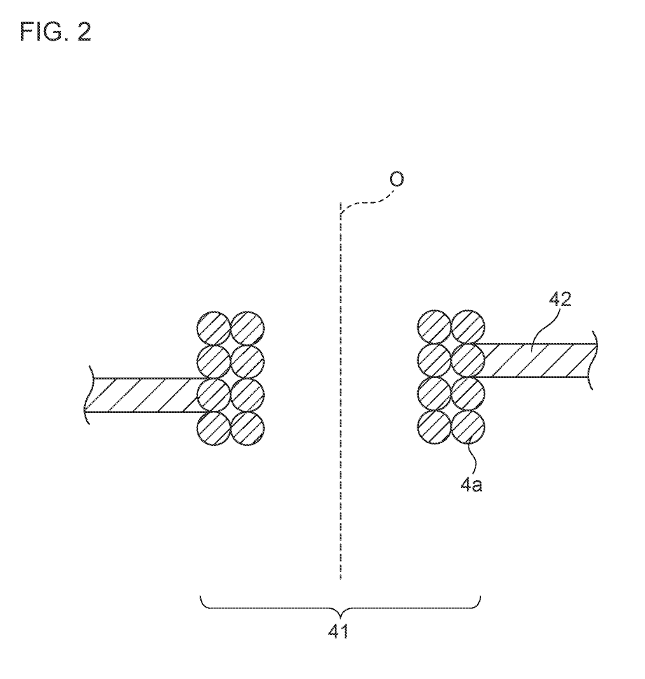

As shown in FIG. 2, air-core coil 41 is formed by winding wire 4a, and lead 42 is led from air-core coil 41. In the present embodiment, air-core coil 41 is a part where wire 4a wound around a hollow cylindrical foam. Said air-core coil is buried inside core 2, making winding axis O vertical to both principal surfaces 2a and 2b of core 2.

In addition, at least a pair of lead 42, which is both ends of wire 4a, is led outside of core 2 from air-core coil 41. The led out wire 4a, lead 42, is electrically connected to a pair of terminal part provided on an outer circumferential surface of core 2. Note, a terminal part is not particularly limited, and a well-known configuration can be applied.

When voltage is applied to the terminal part, the electrical current flows in wire 4a and a magnetic flux generates penetrating a hollow part of air-core coil 41, and thus, the coil device exhibits a predetermined magnetic characteristic.

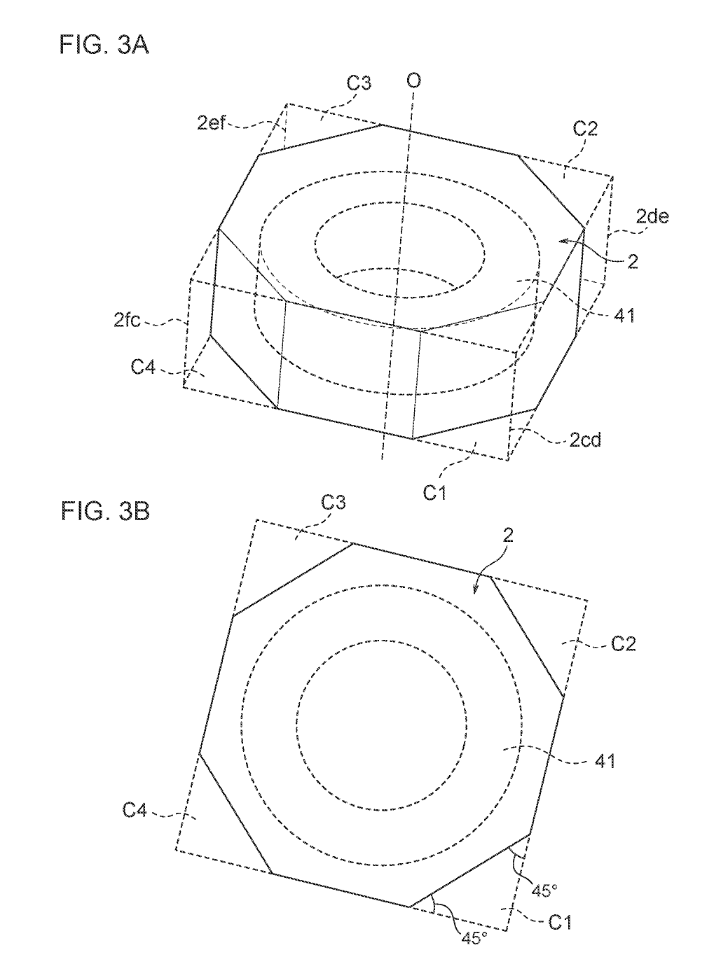

In the present embodiment, as shown in FIGS. 3A and 3B, core 2 having a regular octagonal pillar outer shape has a constitution in which four corner parts C1 to C4 of an equilateral quadrangular pillar shape are removed at surfaces, which are inclined to surfaces composing the corner parts by 45 degrees. The four corner parts are removed by C chamfering. FIGS. 3A and 3B show the removed parts (corner parts C1 to C4) by dotted lines.

Note, core 2 in which four corner parts are preliminary removed may be formed by using such as a mold, corresponding to core 2 of the regular octagonal pillar shape in which four corner parts are removed. And core 2 may be formed by removing four corner parts of a rectangular parallelopiped core by C chamfering. In the present embodiment, the four corner parts are preferably removed by C chamfering, however, the removed amount by the chamfering in the present embodiment is excessively large relative to the same by a chamfering in general. A general chamfering amount performed to the coil device is performed aiming to prevent breakage of the coil device such as chipping, and the corner part is not largely removed as in the present embodiment.

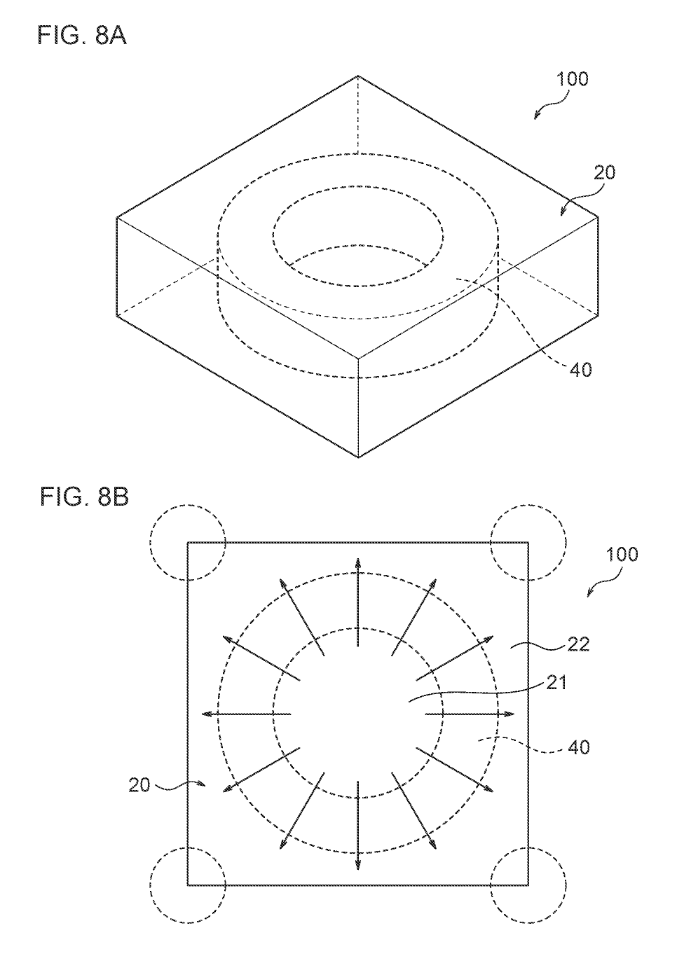

An outer shape of the core before removing the corner part is an equilateral quadrangular pillar, which is similar to the same of the core of the coil device shown in FIG. 8. As mentioned above, the coil device as shown in FIG. 8 has a round outer circumference shape of a magnetic body disposed inside the air-core coil. Thus, a magnetic flux generated by an electrical current flowing in the coil becomes radial from inside to outside of the air-core coil. Most of said magnetic flux progresses along an outer circumferential surface of the air-core coil. Therefore, a magnetic flux generated at the corner part shown by a dotted line in FIG. 8 is less.

Therefore, although the core including the magnetic powder exists to increase the inductance, a contribution of the magnetic flux generated at the corner parts shown in FIG. 8 with respect to the magnetic characteristics of the coil device, is very small. Thus, it is difficult to say that the corner part is efficiently used to increase the inductance.

In other words, by removing the parts, which does not contribute to the magnetic characteristics of the coil device, the magnetic body can be efficiently used while the magnetic characteristics of the coil device are maintained. Namely, used amount of the magnetic body of the coil device can be efficiently reduced, a property per volume of the core can be enhanced, and a weight reduction of the coil device can also be realized.

Therefore, in the present embodiment, as shown in FIGS. 3A and 3B, corner parts including all sides parallel to winding axis O of air-core coil 41 are removed from the equilateral quadrangular pillar of the rectangular parallelepiped shape. The corner parts are C1 including a side 2cd, C2 including a side 2de, C3 including a side 2ef and C4 including a side 2fc. Thus, by making the volumes of the removed corner part to 2% or more, preferably 3% or more, with respect to 100% volume of the equilateral quadrangular pillar before removing the corner parts, the used amount of the magnetic body can be efficiently reduced, while the magnetic characteristics of the coil device are maintained.

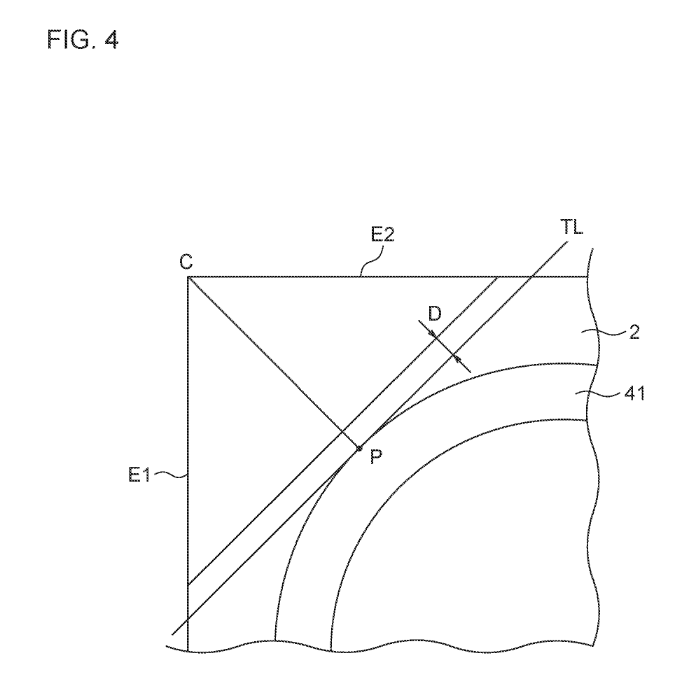

In addition, to enhance the property per volume of the core, it is preferable to set a size of the removing corner part within a determined range considering a size of the air-core coil. FIG. 4 is a part plane of core 2 in a view from the direction of the winding axis of air-core coil 41, and is a figure showing the size range of the removing part. In FIG. 4, core 2 is an equilateral quadrangular pillar shape and air-core coil 41 is a cylindrical shape. Tangential line TL drawn at Point “P”, which is a shortest distance from corner part “C” on winding 41, forms an angle of 45° to both sides E1 and E2 forming core 2.

If corner part C is removed from core 2 along this tangential line, the used amount of magnetic body can be mostly reduced. However, when the magnetic flux proceeds around from inside to outside of winding 41, the magnetic body existing outside of winding 41 is less making generation of the magnetic flux less, and as a result, the magnetic characteristics of the coil device are deteriorated.

On the other hand, when exceedingly remote from tangential line TL in a direction toward corner part C, in a direction away from air-core coil 41, the magnetic characteristics are good, however, not effectively used magnetic body part increases and the property per volume is lowered.

Therefore, a line parallel to tangential line TL is disposed with a distance D of 0.01 mm or more from point P, in a direction toward corner part C from tangential line TL, and said corner part C is preferably removed along said line. By making the removing part of corner part C within the above range, the property per volume of the coil device can be enhanced.

Coil device according to an embodiment of the invention are preferable for the coil device in which a high frequency and a large current are demanded. Said coil device is, for instance, a power circuit such as a DC-DC converter loaded on a personal computer, a portable electronic device, etc., and a choke coil of a power supply line loaded on a personal computer, a portable electronic device, etc.

### 1.2 The Second Embodiment

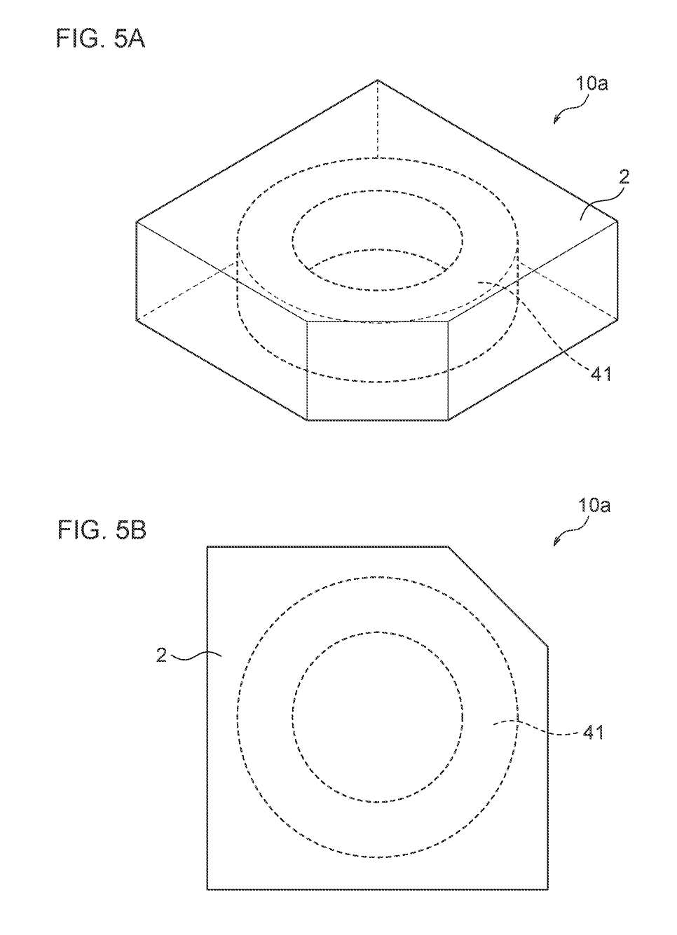

As shown in FIGS. 5A and 5B, the coil device 10a according to the second embodiment is the same with coil device 10 of the first embodiment, except the removed corner part is one. Therefore, repeated description is omitted. Coil device 10a according to the present embodiment can exhibit the same effect as coil device 10 according to the first embodiment.

### 1.3 The Third Embodiment

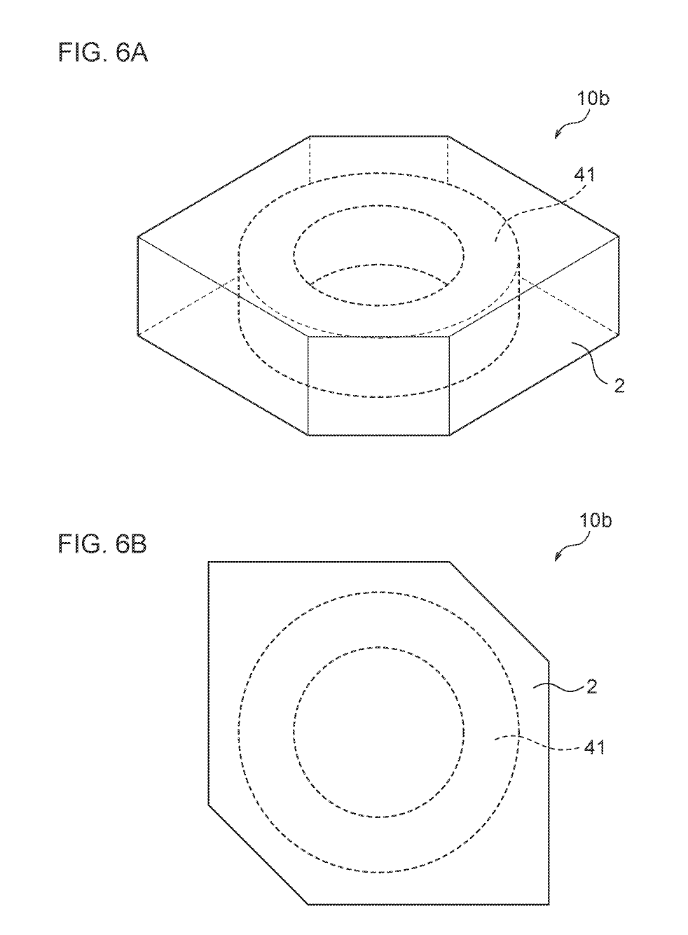

As shown in FIGS. 6A and 6B, the coil device 10b according to the third embodiment is the same with coil device 10 of the first embodiment, except the removed corner part is two. Therefore, repeated description is omitted. Coil device 10b according to the present embodiment can exhibit the same effect as coil device 10 according to the first embodiment.

### 1.4 The Fourth Embodiment

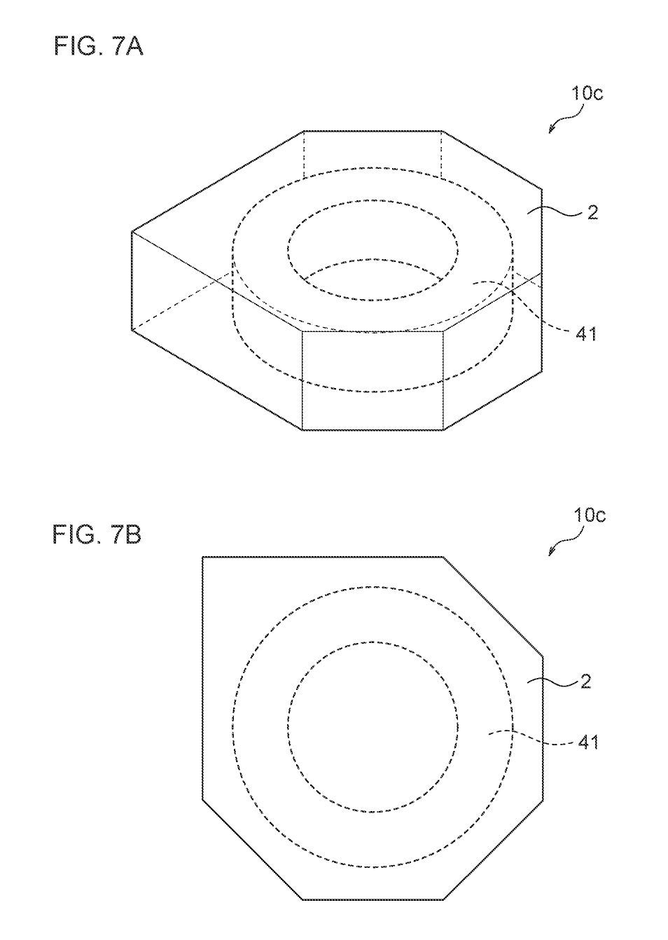

As shown in FIGS. 7A and 7B, the coil device 10c according to the fourth embodiment is the same with coil device 10 of the first embodiment, except the removed corner part is three. Therefore, repeated description is omitted. Coil device 10c according to the present embodiment can exhibit the same effect as coil device 10 according to the first embodiment.

### 2. Effects of the Embodiments

According to the above described embodiments, the core part, in which the cylindrical shaped air-core coil part is buried, has an outer shape configured by removing the corner part of the rectangular parallelepiped shape. Said corner part has exceedingly less contribution to the magnetic characteristics of the coil device.

Therefore, the coil device superior in the magnetic characteristic and the reduction of the used amount of the magnetic body can be both realized without fail. In addition, the removal of the corner part is C chamfered, thus, the corner part is easily removed without complicating manufacturing step.

In particular, by making an outer shape of the core to the regular octagonal pillar shape, in addition to the above effects, a higher degree of freedom for forming a terminal part at the outer circumference of the core is achieved.

Hereinbefore, embodiments of the invention are described, but the invention is not limited thereto. The invention can be varied in various modes within a range of the invention.

### 3. Modified Examples

The above embodiments describe that the cross section of the air-core coil part is a round shape. Shape of the air-core coil part, however, is not particularly limited as long as it has a hollow shape. For instance, it may have a polygonal cross section. In this case, the corner part is preferably removed along a line, which passes through a vertex of the cross section of the air-core coil part, and inclined to both sides E1 and E2 of FIG. 4, by 45 degrees.

In addition, the above embodiments show the air-core coil part configured by winding the wire around said part for plural times; however, it may be configured by a ring shaped conductor of a roll.

Further, in the above embodiments, an outer circumferential surface of the core is newly formed after removing corner parts of the equilateral quadrangular pillar, and a new corner part is also formed. General chamfering may be formed to the newly formed corner part. In this case, R chamfering is preferable to make the corner part to a round surface.

### EXAMPLES

### Example 1

Hereinafter, the invention will be described referring to the examples, however, the invention is not limited thereto.

The metal magnetic material powder mainly composing iron as the magnetic powder and the epoxy resin as the resin were mixed, and granulated thereof. Subsequently, the air-core coil, manufactured using an insulating coated copper wire, and the granules, obtained by the granulation, were fed into a mold, pressure molded thereof by a predetermined pressure, and the air-core coil buried mold was obtained. Considering the shape of the mold, a sample (Ex. 1) having a shape, in which one corner part is C chamfered, a sample (Ex. 2) having a shape, in which two corner parts are C chamfered, a sample (Ex. 3) having a shape, in which three corner parts are C chamfered, a sample (Ex. 4) having a shape, in which four corner parts are C chamfered, and a sample (Comp. Ex. 1) having a shape, in which corner parts are not C chamfered were obtained. Heat treatment was performed to the samples at a predetermined temperature, and the coil devices were obtained. Note, the size of the coil device according to Ex. 4 was a regular octagonal pillar, having a side of 4.1 mm and a height of 4 mm. Further, the size of the coil device according to Comp. Ex. 1 was an equilateral quadrangular pillar, having a side of 10 mm and a height of 4 mm. Volume of the coil device was calculated from the size of the coil device according to Ex. 1 to 4, and ratios with respect to the volume of the coil device according to Comp. Ex. 1 were obtained. Results are shown in Table 1.

An initial inductance value and a saturation characteristic of an inductance value when DC superimposed were evaluated to the samples of the obtained coil device. LCR meter, 4284A made by Agilent Technology, was used for the measurement of the inductance value, and DC electrical current was applied using DC bias power source, 42841A made by Agilent Technology.

The initial inductance value is an inductance value, in which DC electrical current is not applied. The saturation characteristic of the inductance value when DC superimposed, is an inductance value when DC electrical current of 16 A and 20 A are applied.

The larger the initial inductance value is, the superior the property of the coil device is. As the inductance value when DC superimposed is larger, a high inductance value can be maintained till a range of large current, and the DC superposition characteristics, an index indicating the magnetic saturation characteristic, is superior. Results are shown in Table 1. “A volume ratio of the core” in Table 1 is a volume ratio showing an outer shape of the core.

TABLE 1

| | Chamfering of outer | | | | |
|---|---|---|---|---|---|
| | peripheral corner | | | | |
| | part of core | | | Inductance | |
| | (C chamfering | | Initial | when DC | |
| | at 45°) | | inductance | superimposed | |
| | Number of | Volume ratio | [μH] | [μH] | |
| | disposal | of core | DC = 0A | DC = 16A | DC = 20A |
| Ex. 1 | 1 | 0.95 | 3.24 | 2.82 | 2.43 |
| Ex. 2 | 2 | 0.89 | 3.24 | 2.82 | 2.43 |
| Ex. 3 | 3 | 0.84 | 3.23 | 2.81 | 2.43 |
| Ex. 4 | 4 | 0.78 | 3.23 | 2.81 | 2.43 |
| Comp. | 0 | 1.00 | 3.25 | 2.82 | 2.43 |
| Ex. 1 | | | | | |

The initial inductance value and the saturation characteristic of the inductance value when DC superimposed of the samples according to Ex. 1 to 4 all showed an equivalent characteristic to the same of comparative example 1, in spite of a small volume of the core relative to the same of Comp. Ex. 1.

In addition, the larger the number of the removed corner part is, the larger the effect of reducing the volume of the core is. And in particular, it was confirmed that the effect is largest in Example 4, in which four corner pars are removed.

Results of Table 1, converted to the property per volume of the coil device, are shown in Table 2.

TABLE 2

| | Chamfering of outer | | | | |
|---|---|---|---|---|---|
| | peripheral corner | | | | |
| | part of core | | Property per core volume | | |
| | (C chamfering | | (each characteritic | | |
| | at 45°) | | values of Table 1/ | | |
| | Number of | Volume ratio | volume ratio of core) | | |
| | disposal | of core | DC = 0A | DC = 16A | DC = 20A |
| Ex. 1 | 1 | 0.95 | 3.41 | 2.97 | 2.56 |
| Ex. 2 | 2 | 0.89 | 3.64 | 3.17 | 2.73 |
| Ex. 3 | 3 | 0.84 | 3.85 | 3.35 | 2.89 |
| Ex. 4 | 4 | 0.78 | 4.14 | 3.60 | 3.12 |
| Comp. | 0 | 1.00 | 3.25 | 2.82 | 2.43 |
| Ex. 1 | | | | | |

It was confirmed that samples of Example 1 to 4 show higher property per volume relative to the same of Comparative Example 1.

### NUMERICAL REFERENCES

10, 10a, 10b, 10c . . . Coil device
2 . . . Core
4a . . . Wire
41 . . . Winding
42 . . . Lead

1. A coil device comprising:
a core, including a magnetic powder and a resin;
an air-core coil; and
a lead, led from the air-core coil, wherein
at least the entire air-core coil is buried inside the core,
an outer shape of the core is a shape where at least one corner part is removed from an approximate rectangular parallelepiped shape,
the removed corner includes an entire side of the approximate rectangular parallelepiped shape in the removed corner, approximately parallel to a direction of a winding axis of the air-coil, and
a volume of the removed part is 2% or more of a volume of the approximate rectangular parallelepiped shape.

2. The coil device according to claim 1, wherein the corner part is removed by C chamfering.

3. The coil device according to claim 1, wherein two or more of the corner parts are removed.

4. The coil device according to claim 1, wherein three or more of the corner parts are removed.

5. The coil device according to claim 1, wherein four of the corner parts are removed.

6. The coil device according to claim 5, wherein the outer shape of the core is an approximate regular octagonal pillar shape.
